(19) United States
(12) Patent Application Publication
(10) Pub. No.: US 2023/0182795 A1
(43) Pub. Date: Jun. 15, 2023

(54) OUTDOOR MOBILE OFFICE POD

(71) Applicant: SIMON Dubé-Sexton, Cumberland (CA)

(72) Inventors: Simon Dubé-Sexton, Cumberland (CA); Charlene Sexton, Cumberland (CA)

(21) Appl. No.: 18/078,149

(22) Filed: Dec. 9, 2022

(30) Foreign Application Priority Data
Dec. 10, 2021 (CA) 3141966

(51) Int. Cl. B62B 3/00; B62B 5/06; B62B 5/00

(52) U.S. Cl. CPC B62B 3/002; B62B 5/00; B62B 5/06; E04H 1/12

(57) ABSTRACT

There is provided an outdoor mobile office pod, which is affordable and mobile to combine working with travelling, off-grid living and other adventurous work setups. The pod allows remote workers to increase their vitamin D intake and to breathe fresh air while working in a comfortable environment sheltered from inconsistent weather in order to have a positive impact on mental health. In one aspect, there is provided a mobile office pod with one or more walls made from impact resistant acrylic. At least four wheels are configured to be attached to the pod, for example at an external side and at least one levelling jack is configured to be attached to the pod, for example at an external side.

### CROSS-REFERENCE TO RELATED APPLICATION

This application claims the priority benefit of Canadian Patent Application No. 3,141,966, filed on Dec. 10, 2021, the disclosure of which is incorporated by reference herein in its entirety.

### TECHNICAL FIELD

In general, this disclosure relates to a mobile office pod. Preferably, the mobile office pod is for use outdoors.

### BACKGROUND

Indoor office booths have been in existence for many years. Common names for such booths are cubicles, stalls, workspaces or pods. Office booths offer privacy and create a positive work atmosphere. An example office booth is shown in U.S. Design Pat. No. USD844818.

Outdoor offices or workstations have also been in existence for a period of time. Some homeowners have built tiny permanent offices in their backyards. Commercial enterprises in the construction industry have also been using mobile offices in the format of big containers mounted on trailers. Such containers, portables or mobile offices can often be seen at construction sites next to roads or buildings under construction.

Teleworking has become a new normal and standard of operation for millions of workers. Although many employees enjoy working from home, many remote workers miss being able to work in a different environment. The boundary between work-time and leisure-time has become blurred for many, along with a growing mundane view of spending both working time and leisure time in the same environment. While employees may select where to work, many do not have access to adequate office materials such as Wi-Fi, a chair, a table, etc. unless they work from home or the office.

A further disadvantage of teleworking is the fact that many workers are working longer hours as a result of teleworking and there is an increasing negative effect on remote workers’ mental health.

In order to alleviate the above problems, some people have converted vans or built tiny stationary buildings in their backyard to use as an office; however, such solutions are very costly. There is also an increase in availability of mental health programs that promote a healthy work/life balance; however, such programs often require a large commitment for a beneficial return on investment.

### SUMMARY

The outdoor mobile office pod of the present invention is configured to allow remote workers to have an affordable workstation in their backyard. More precisely, remote workers who are interested in exploiting the full advantages of remote working may use the outdoor mobile office pod to combine working with travelling, off-grid living and other adventurous work setups. Working outdoors has a positive impact on mental health. The pod allows remote workers to increase their vitamin D intake and to breathe fresh air while working in a comfortable environment sheltered from inconsistent weather.

Working outdoors in a mobile fashion presents many challenges not found in a stationary office location. For example, the ground is typically uneven, weather is inconsistent and can be menacing, movement of a pod places great stress on the physical structure, and the weight of an outdoor office makes movement very difficult. Furthermore, including power and access to the outdoors from within the pod presents further challenges.

The present invention sets forth a mobile office pod with many advantages.

In one aspect, there is provided a mobile office pod, comprising one or more walls made from impact resistant acrylic; a base; at least four wheels configured to be attached to an external side of the pod; and at least one levelling jack configured to be attached to an external side of the pod.

### BRIEF DESCRIPTION OF THE DRAWINGS

The invention will be further understood from the following description with reference to the attached drawings.

FIG. 1 illustrates a schematic drawing of one embodiment showing a table and chair inside the pod;

FIG. 2 illustrates a schematic drawing of one embodiment showing the location of the door;

FIG. 3 illustrates a schematic drawing of one embodiment showing blinds and an air conditioner;

FIG. 4 illustrates a schematic drawing of one embodiment showing Wi-Fi or satellite communication and a power bank;

FIG. 5 illustrates a schematic drawing of one embodiment showing handles and wheels;

FIG. 6 illustrates a schematic drawing of one embodiment showing a screen and sliding plexiglass;

FIG. 7 illustrates a perspective view of an example embodiment of the pod;

FIG. 8 illustrates a perspective view of another example embodiment of the pod;

FIG. 9 illustrates a perspective view of the front side of FIG. 7;

FIG. 10 illustrates an example enlarged fragmentary view of FIG. 7;

FIG. 11 illustrates an example enlarged fragmentary view of FIG. 7; and

FIG. 12 illustrates an example enlarged fragmentary view of FIG. 7.

### DETAILED DESCRIPTION

The exemplary embodiments of the present disclosure are described and illustrated below for example purposes only. Of course, it will be apparent to those of ordinary skill in the art that the embodiments discussed below are exemplary in nature and may be reconfigured without departing from the scope and spirit of the present disclosure. However, for clarity and precision, the exemplary embodiments as discussed below may include optional steps, methods, and features that one of ordinary skill should recognize as not being a requisite to fall within the scope of the present disclosure.

In one aspect of the present invention there is provided an outdoor mobile office pod that is designed to be used off-grid. The pod is preferably weather resistant and impact resistant in order to sustain impacts during transportation. In one example, the pod may include wheels to be mobile. In addition, the pod may include necessary office materials such as table(s), chair(s), Wi-Fi, a power bank, and off grid air conditioning. Furthermore, a heater may be optionally provided.

In one example embodiment, a person may telework inside of the outdoor mobile office pod. The pod may be rolled to a desired location. The mobile office pod of the present invention may include wheels of sufficient size and strength to support the weight of the pod and for a user to be able to move the pod single-handedly.

In a further example embodiment, the pod may include optional tie downs to permit the user to strap the pod onto a small utility trailer to permit transportation. For example, the pod may be placed on top of a trailer that is pulled by an automotive vehicle so the user may travel long distances with the pod to the desired location for teleworking, such as for movement of the pod from a house to a cottage or any other desired location. Such tie-down straps may be optionally used to restrict motion of the pod once in location. Alternatively, or in addition, tie-down clips may be provided on the external side(s) of the pod to attach to a separate strap. Within the pod, interior tie-down clips may optionally be used with straps or ropes to restrict movement of items within the pod during transportation of the pod.

Movement of the pod on uneven terrain and onto the back of trailers and flatbeds could create an enormous strain on the pod. Plexiglass™ of sufficient strength to withstand stress and strain is optionally recommended throughout the structure of the pod. The walls and ceiling are optionally made of Plexiglass or any other impact resistant acrylic to prevent breakage caused by bumping or jarring of the pod during movement over uneven terrain or during transportation. One example type of impact resistant acrylic that could be used is clear acrylic with a 10 mm thickness. The walls and ceiling may be made of any impact resistant material.

In a further example embodiment, the mobile office pod has at least four leveling jacks to level the pod on uneven terrain. Built-in wheels and leveling jacks may permit a wide range of movement, security and stability in any form of uneven terrain.

At least four wheels may be configured to be attached to the pod, for example attached to an external side of the pod. The wheels may be attached to the base, attached underneath the pod, attached alongside the pod, attached to the wall beams, or attached at any other suitable location. In one example embodiment, at least one levelling jack is configured to be attached to the pod, for example attached to an external side of the pod. The leveling jack(s) may be attached to the base, attached underneath the pod, attached alongside the pod, attached to the wall beams, or attached at any other suitable location. Alternatively, the levelling jack(s) and/or wheels may be attached to an external side of the wall of the pod. The jack(s) and/or wheels could be located on any external side of the pod, under the pod or on a vertical side of the pod. If multiple levelling jacks are used, each levelling jack may be actuated separately to enable secure and level placement of the entire pod. Furthermore, in another example embodiment, the wheels and levelling jack(s) may be combined together into a single unit.

Many end users would be interested in working within their own backyard, without the hassle of transporting the mobile office pod on a flatbed or trailer. Most homeowners do not have access to a vehicle with a hitch, a flatbed trailer and/or a truck for transportation of the mobile office pod. For use at home, most backyards are fenced with a standard size gate entry of 36 to 48 inches wide. In one example embodiment, the present invention has a width or length less than the size of a standard gate in order to permit easy access to the backyard. Once the user rolls the mobile office pod through their gate, they may then move the mobile office pod to the desired location in their backyard. Once in the backyard, it would be possible for a user to move the mobile office pod throughout the day in order to achieve their desired sun and shade balance. The mobile office pod may optionally include push handles on one or more corners or sides in order to enable simple movement of the pod by a single person. Alternatively, different widths and lengths of the pod may be made to suit the needs of the user.

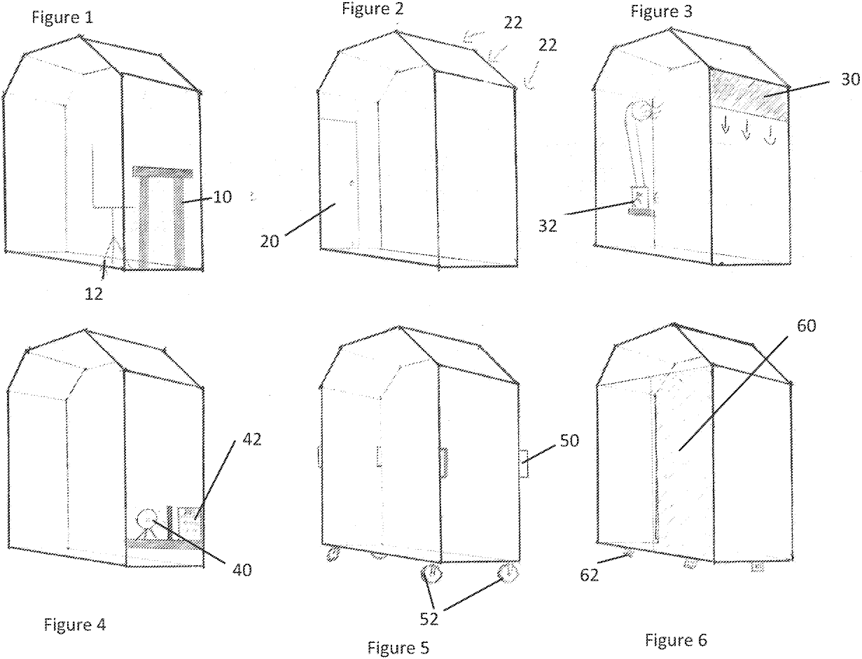

FIGS. 1 to 6 illustrate various optional components of the mobile office pod. FIG. 1 illustrates a schematic drawing of one embodiment showing the manner in which a table 10 and chair 12 may be arranged inside the pod.

FIG. 2 illustrates a schematic drawing of one embodiment showing a sample location of the door 20. Any such door may be assembled according to the user’s preference. For example, the door may open outward or inward, or may be provided on a longer side of the pod to enable a sliding door. The door may be provided with a screen, as solid glass, as partial glass or as a solid door. The door may optionally include a locking mechanism to permit locking from the inside and/or the outside. Plexiglass 22 is shown on the roof and walls.

FIG. 3 illustrates a schematic drawing of one embodiment showing an example arrangement of optional blinds 30 and an air conditioner 32. The blinds 30 may be provided within the pod, while the air conditioner 32 may be provided externally, or internally if desired. Furthermore, a heater may be optionally provided.

FIG. 4 illustrates a schematic drawing of one embodiment showing optional Wi-Fi or satellite communication 40 and a power bank 42. The power bank 42 or portable battery may be charged with a generator or by plugging into a power outlet. As an alternative, or in addition, the interior of the pod may optionally include a power outlet directly connected to a power cord which may be directly plugged into an outdoor power receptacle to connect to the electricity provided by a building or house.

FIG. 5 illustrates a schematic drawing of one embodiment showing optional handles 50 and wheels 52. Although the wheels are shown mounted on the bottom, other configurations and placement of the wheels are possible.

FIG. 6 illustrates a schematic drawing of one example embodiment showing a screen 60 and sliding plexiglass. Optional tiedowns 62 can be included on the bottom of the pod to secure the pod from moving on the ground or during transportation on the back of a flatbed trailer or truck. The tiedowns may be positioned in a location different than that shown in FIG. 6; for example, tiedowns could be included part-way up the side of the pod. The tiedowns may include holes for a rope or bungee cord or stake, or the tiedowns may be adapted for use with a ratchet or for connection to buckles of prefabricated straps.

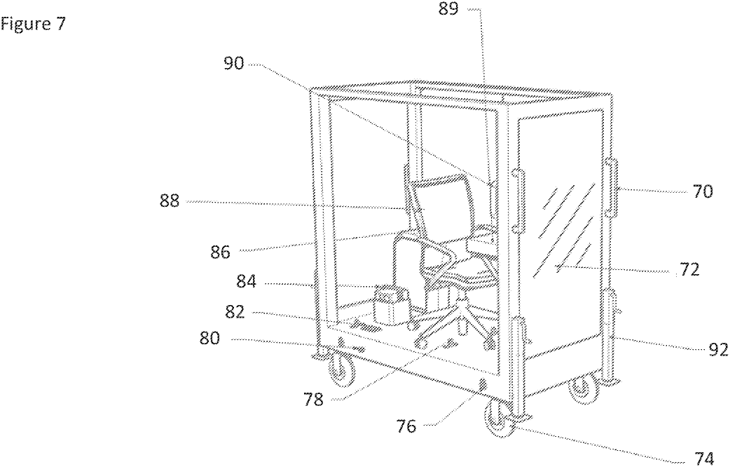

FIG. 7 illustrates an example embodiment of the present invention. Push handles 70 are provided on the short sides of the pod. Each side of the pod contains an acrylic window 72. Four wheels 74 are mounted to the external side of the base of the pod. Exterior tie down clips 76 and interior tie down clips 78 are provided. A power inlet 80 is provided to connect an extension cord or other power cord to a power outlet on a house or other structure. An electrical outlet 82 is provided inside the pod. An alternative power source 84 is provided via a portable battery bank, while an air conditioner 86 is provided within the structure. An example arrangement of a desk chair 88 along with a desk 89 that may be foldable is shown. Exterior doors 90 are provided on a long side of the pod.

In one aspect, four levelling jacks 92 are mounted on the sides of the pod, two on each end. Each levelling jack has a case and a crank or handle. There is a flat foot mounted at the bottom of a post which fits within the case. When the handle is turned, a gear system transfers the rotation of the handle to teeth that are formed along the post in order to raise or lower the post depending on the direction of rotation of the handle. Each levelling jack can be actuated separately to enable secure and level placement of the entire pod.

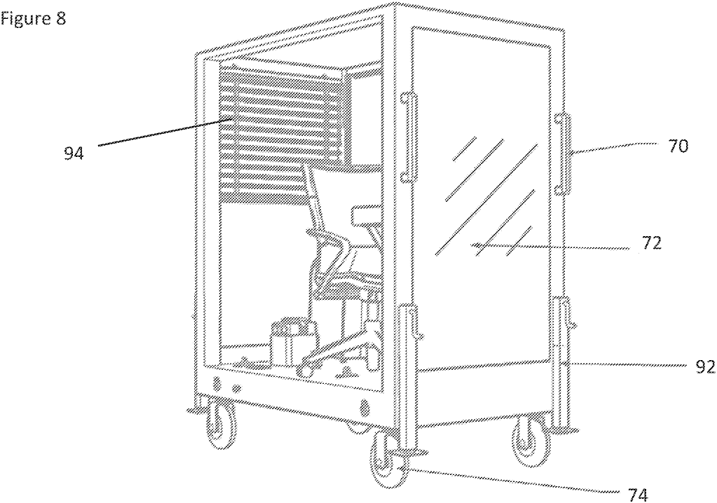

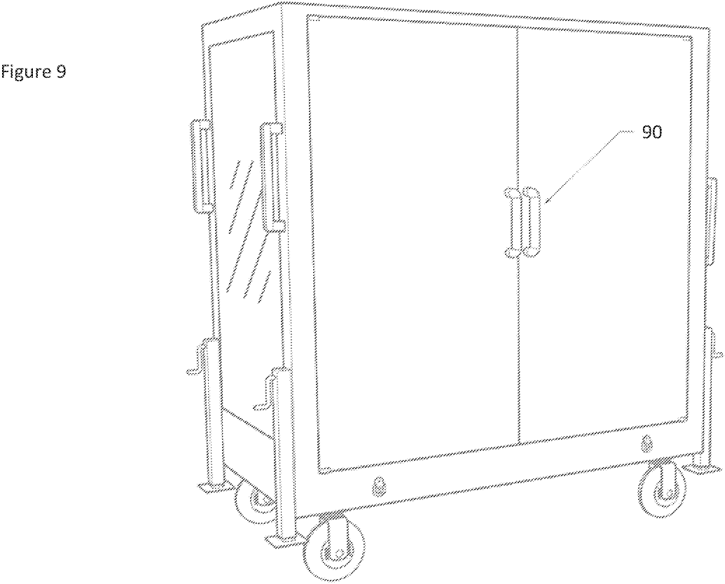

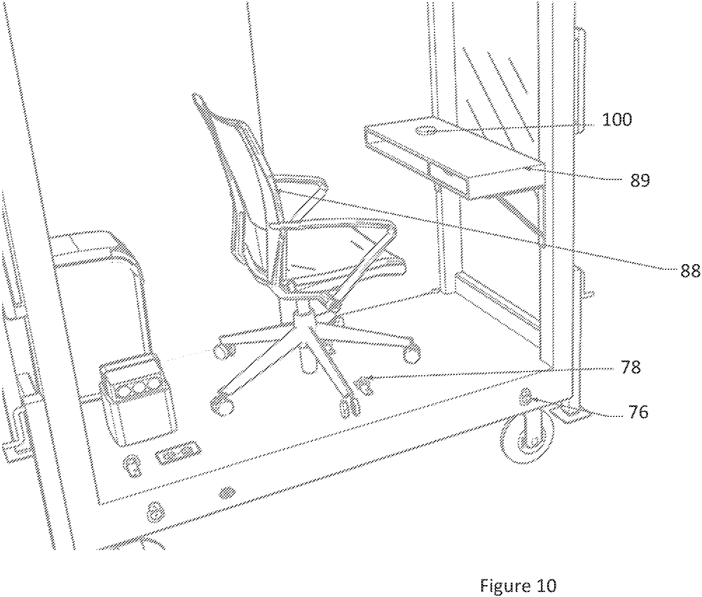

FIG. 8 shows an example embodiment of the present invention, wherein the pod has one or more blinds 94 that can be opened and closed.

FIG. 9 illustrates a perspective view of the front side of FIG. 7, showing an example embodiment of the doors 90 on the long side of the pod.

FIG. 10 illustrates an example enlarged fragmentary view of FIG. 7, showing an example arrangement of the articles within the pod. A wireless hotspot 100 or connection may be provided on the desk 89.

FIG. 11 illustrates an example enlarged fragmentary view of FIG. 7, showing an example arrangement of the articles within the pod, including the air conditioner 86, alternative power source 84, electrical outlet 82, and a power inlet 80.

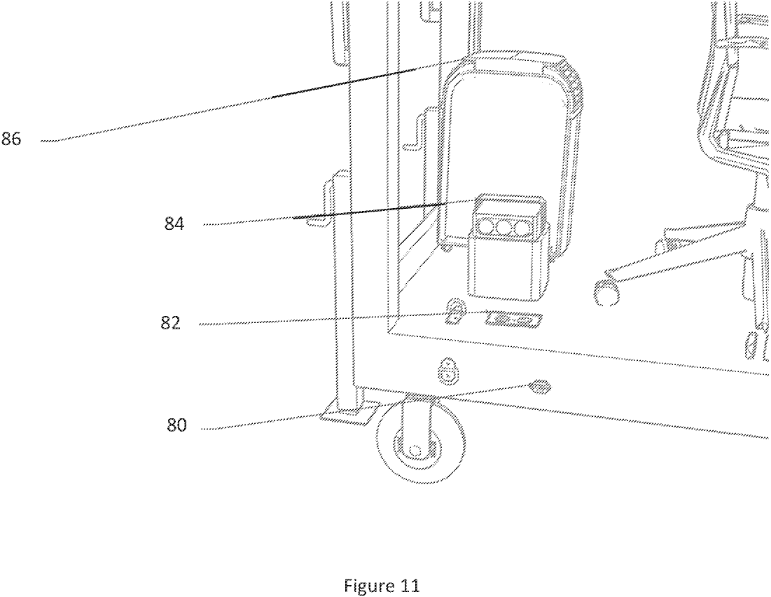

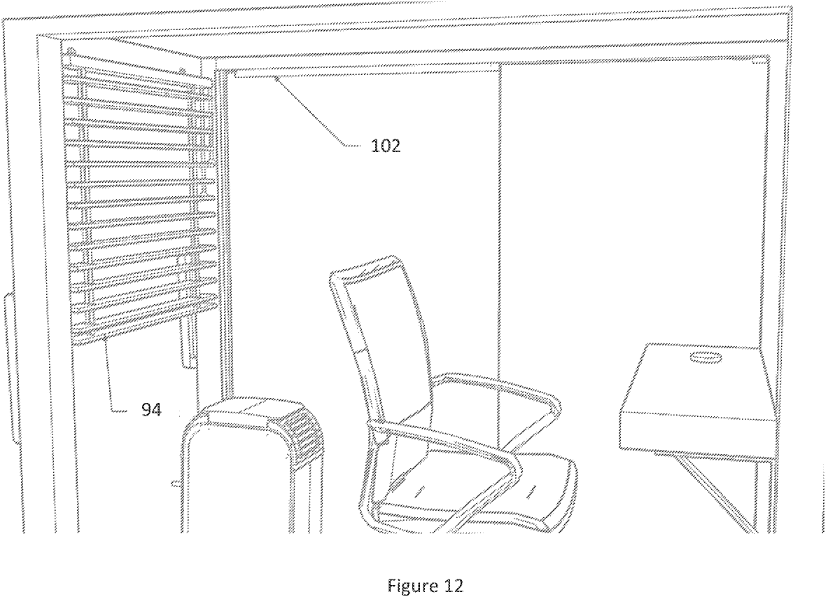

FIG. 12 illustrates an example enlarged fragmentary view of FIG. 7, showing one of the blinds 94 that may be opened and closed. An optional screen 102 is also illustrated.

### Example 1

Josée is a teleworker. She is working long hours and is struggling with mental health. Her doctor has recommended that she spend more time outside. Josée buys the outdoor mobile office pod of the present invention and sets it in her back yard right beside her beautiful tree. She can now work while having a fresh breeze and beaming sun on her face. The pod is covered in Plexiglass and has two sliding panels to permit fresh air to circulate. On hot days she may turn on a battery powered AC unit. She may optionally charge both the AC unit’s battery and power bank during her off hours.

### Example 2

Martin is a high energy individual who loves to telework and craves adventure. Martin buys the mobile office pod of the present invention to work and camp for a few weeks in the summer. He also brings his pod to his parent’s cottage and teleworks from there. He charges his power bank and AC unit with the help of a generator.

It will be appreciated by one skilled in the art that variants can exist in the above-described arrangements and applications. For example, any form of impact resistant acrylic may be used instead of Plexiglass. Screens, window openings and sliding blinds may be included on one or all of the sides in order to enable a user to set up the preferred arrangement of airflow. While the drawings illustrate one shape and size of the mobile office pod, it will be appreciated that the pod can be formed in other shapes and sizes as desired for the end-use application. In addition, a heater may be included, with or without the air conditioner. The frame and/or wall beams of the pod may be constructed of steel, aluminum, wood or any other suitable structural material.

Following from the above description, it should be apparent to those of ordinary skill in the art that, while the methods and apparatuses herein described constitute exemplary embodiments of the present invention, the invention described herein is not limited to any precise embodiment and that changes may be made to such embodiments without departing from the scope of the invention as defined by the claims. Consequently, the scope of the claims should not be limited by the preferred embodiments set forth in the examples but should be given the broadest interpretation consistent with the description as a whole. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A mobile office pod, comprising:
one or more walls made from impact resistant acrylic;
a base;
at least four wheels configured to be attached to the pod; and
at least one levelling jack configured to be attached to the pod.

2. The mobile office pod of claim 1 wherein the base has dimensions of width and length, and at least one of the dimensions is less than 48 inches.

3. The mobile office pod of claim 1 further comprising a power bank that is rechargeable by a generator or 120 V AC.

4. The mobile office pod of claim 1 further comprising one or more handles mounted on an external surface of the one or more walls.

5. The mobile office pod of claim 1 further comprising one or more tie-downs attached to an external side of the pod.

6. The mobile office pod of claim 1 further comprising at least one screen.

7. The mobile office pod of claim 1 further comprising one or more blinds inside the pod.

8. The mobile office pod of claim 1 further comprising an air conditioning unit.

9. The mobile office pod of claim 1 further comprising a power inlet to connect the pod to an external power source.

10. The mobile office pod of claim 1 further comprising interior tie-down clips.

11. The mobile office pod of claim 1 further comprising exterior tie-down clips.

12. The mobile office pod of claim 1 comprising four wheels and four levelling jacks.

13. The mobile office pod of claim 12 wherein the levelling jacks are attached to the side of the pod.

14. The mobile office pod of claim 13 wherein each of the levelling jacks comprise a handle, a foot, and a case.

15. The mobile office pod of claim 1 wherein the wheels are attached at a location selected from the group consisting of the base, underneath the pod, alongside the pod, and wall beams.

16. The mobile office pod of claim 1 wherein the at least one levelling jack is attached at a location selected from the group consisting of the base, underneath the pod, alongside the pod, wall beams, and any combination thereof.

17. The mobile office pod of claim 1 further comprising a heater.

18. The mobile office pod of claim 1 further comprising a frame constructed of a material selected from the group consisting of steel, aluminum, and wood.
